(19) United States
(12) Patent Application Publication
(10) Pub. No.: US 2009/0307235 A1
(43) Pub. Date: Dec. 10, 2009

(54) DATA COPY SYSTEM AND METHOD FOR MULTI-PLATFORM DISASTER RECOVERY

(75) Inventors: William A. Atkins, Allen, TX (US); Sandra K.H. Dean, Plano, TX (US); Yi Joanna Feng, Plano, TX (US); Thomas W. Edwards, McKinney, TX (US); Wendy A. Nelson, Princeton, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/543,004

(22) Filed: Aug. 18, 2009

Related U.S. Application Data
(62) Division of application No. 11/383,657, filed on May 16, 2006.

(51) Int. Cl. G06F 12/00; G06F 17/30; G06F 12/16

(52) U.S. Cl. 707/10; 707/202; 707/204; 707/E17.01; 707/E17.032; 711/E12.001; 711/E12.103

(57) ABSTRACT

Method and apparatus for providing disaster recovery with respect to a production mainframe having an operating system encoded in Extended Binary Coded Decimal Instruction Code (EBCDIC). The method includes copying said operating system from a direct access storage device (DASD) of said production mainframe to a file, compressing said file, transferring said file to a remote computer by binary File Transfer Protocol, and storing said file proximate said remote computer.

### CROSS-REFERENCE TO RELATED APPLICATIONS

This application is a divisional of U.S. patent application Ser. No. 11/383,657, filed May 16, 2006, which is herein incorporated by reference.

### TECHNICAL FIELD OF THE INVENTION

The present invention is directed, in general, to computer disaster recovery systems and methods and, more specifically, to a data copy system and method for effecting multi-platform disaster recovery.

### BACKGROUND OF THE INVENTION

Despite the explosive popularity of desktop and laptop personal computers over the last few decades, mainframe computers, minicomputers and network servers, remain indispensable business tools. For example, multinational manufacturing companies use mainframe computers, minicomputers and network servers to control manufacturing machinery (e.g., for fabricating semiconductor devices), manage production resources and schedules, drive enterprise-wide local area networks (LANs) and perform corporate accounting and human resource functions, just to name a few roles.

Unfortunately, mainframe computers, minicomputers and network servers invariably require reliable electric power and often require reasonably dry and temperate environments to operate. As a result, companies often establish central “data centers” to contain their mainframe computers, minicomputers and network servers. For purposes of discussion, these data centers are called “production” data centers, because they are primarily responsible for providing data processing services under normal circumstances. Production data centers are often co-located with major company facilities and provided with state-of-the-art emergency power and climate control systems. Modern production data centers allow mainframe computers, minicomputers and network servers to function properly an impressive percentage of the time. Unfortunately, it is not 100%.

Several types of outages can interfere with the proper function of computers at a production data center. Some may be thought of as short-term, others as long-term. Short-term outages may be brought about, for example, by a temporary loss of electric power, a temporary loss of climate control, a computer failure requiring a reboot, a temporary failure in a communications link or data corruption that requires a minor repair. Long-term outages may happen as a result of, for example, a natural disaster involving the production data center, such as a flood or earthquake, a man-made disaster such as a fire or act of war or a massive data loss requiring significant repair or reconstruction.

As a result, responsible companies invariably take steps to anticipate and prepare for outages at their production data center. Some steps may be quite simple, such as periodically backing up and storing data offsite. However, larger companies almost universally take more elaborate measures to guard against a production data center outage. Often, an alternate, standby data center is established offsite and kept at-the-ready to take the place of the production data center in the event of an outage.

However, merely establishing an offsite standby data center is frequently inadequate in and of itself. Today's multinational manufacturing companies require computers to run their assembly lines; even minutes matter when assembly lines sit idle during a computer outage. Therefore, the speed at which the standby data center becomes available, which can depend upon the order in which computers are booted or rebooted with their operating systems, application programs and data, can matter greatly. Further, the communication links that couple an offsite standby data center to major company facilities may be of a relatively small bandwidth. Those links may be sufficient to supply data processing needs once the standby data center is up and running, but may not be adequate to bear the files required to initialize the operation of the standby data center. Still further, some computers, particularly “legacy” mainframe computers, may employ operating systems, applications and data structures that were not designed to transit modern communication links and networks. Moving files associated with such computers may prove particularly difficult.

U.S. Pat. No. 6,389,552, entitled “Methods and Systems for Remote Electronic Vaulting,” is directed to a network-based solution to facilitate the transportation of production data between a production data center and an offsite storage location. A local access network is used to facilitate data transport from the production data processing facility to the closest long-haul distance network point of presence facility. The point of presence facility houses an electronic storage device which provides the off-site storage capability. A user can then manipulate transportation to data from the production data processing center to the data storage facility using channel extension technology to store the data in electronic form on standard disk or tape storage devices. The user can then recall, copy or transmit the data anywhere on demand under user control by manipulating switching at the point of presence. This subsequent electronic data transfer can be designed to move the critical data on demand at time of disaster to any disaster recovery facility.

Unfortunately, restoring the operation of a production data center or bringing a standby data center online involves more than just moving data from one place to another. It involves getting software back up and running in the data center reliably and in an order that minimizes the time required to restore normal operations of a company as a whole.

Accordingly, what is needed in the art is a comprehensive way to manage the backup and recovery of mainframe computers, minicomputers and network servers and to restore the operation of a production data center following a short-term outage or initialize a standby data center when a long-term outage disables the production data center. What is also needed in the art is one or more recovery techniques that decrease the amount of time required to restore normal operations of a company as a whole.

### SUMMARY OF THE INVENTION

Embodiments of the present invention relate to a Method and apparatus for providing disaster recovery with respect to a production mainframe having an operating system encoded in Extended Binary Coded Decimal Instruction Code (EBCDIC). The method includes copying said operating system from a direct access storage device (DASD) of said production mainframe to a file, compressing said file, transferring said file to a remote computer by binary File Transfer Protocol, and storing said file proximate said remote computer.

### BRIEF DESCRIPTION OF THE DRAWINGS

For a more complete understanding of the invention, reference is now made to the following descriptions taken in conjunction with the accompanying drawing, in which:

FIG. 1 illustrates a block diagram of a computer network infrastructure within which various embodiments of a data copy system for effecting multi-platform disaster recovery constructed according to the principles of the present invention can operate;

FIGS. 2A and 2B illustrate respective flow diagrams of embodiments of a method of backing up a mainframe operating system to a “catcher” computer and a method of restoring the mainframe operating system from the catcher computer carried out according to the principles of the present invention;

FIGS. 3A and 3B illustrate respective flow diagrams of embodiments of a method of backing up a minicomputer operating system to a catcher computer and a method of restoring the minicomputer operating system from the catcher computer carried out according to the principles of the present invention;

FIGS. 4A and 4B illustrate respective flow diagrams of embodiments of a method of forward-storing minicomputer database management system logs to a “pitcher” computer and a method of forward-storing mainframe database management system logs to the pitcher computer carried out according to the principles of the present invention;

FIG. 5 illustrates a flow diagram of an embodiment of a method of transferring data from a pitcher computer to a “catcher” computer carried out according to the principles of the present invention;

FIG. 6 illustrates a flow diagram of an embodiment of a method of cleaning data on a pitcher computer or a catcher computer carried out according to the principles of the present invention;

FIG. 7 illustrates a flow diagram of an embodiment of a method of preventing missed data due to outage of a pitcher computer carried out according to the principles of the present invention;

FIG. 8 illustrates a flow diagram of an embodiment of a method of preventing missed data due to outage of a catcher computer carried out according to the principles of the present invention; and

FIG. 9 illustrates a flow diagram of an embodiment of a method of transferring data to a Microsoft.®. Windows.®.-based catcher computer carried out according to the principles of the present invention.

### DETAILED DESCRIPTION

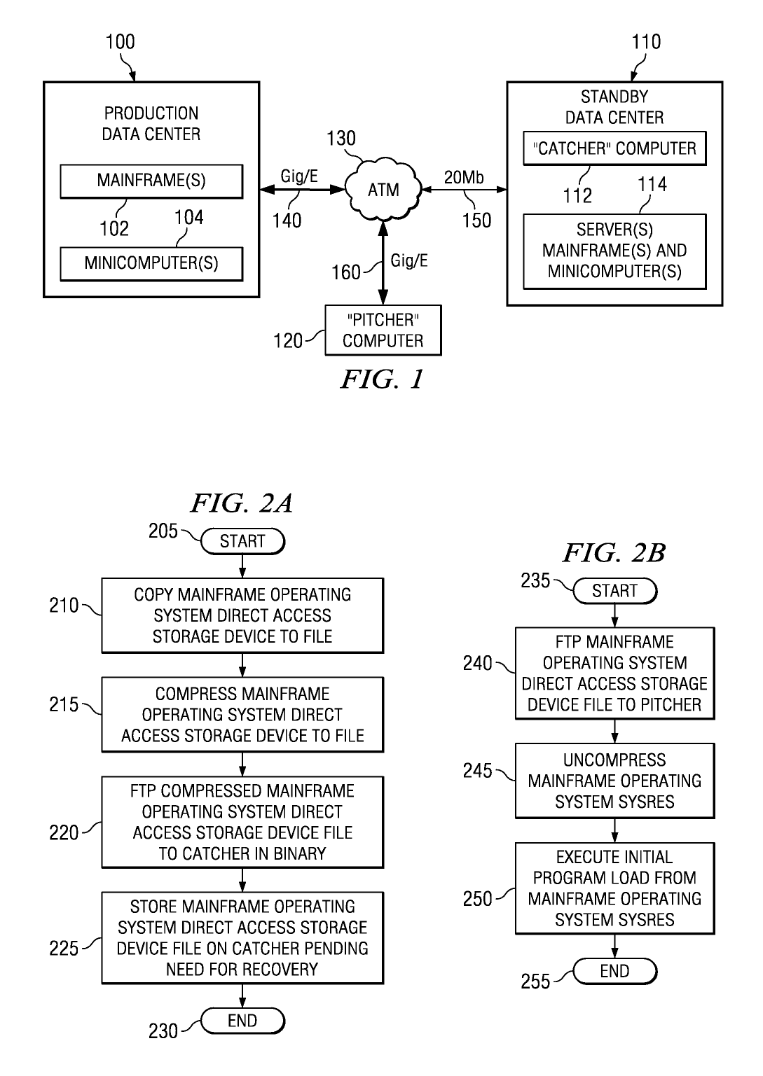

Referring initially to FIG. 1, illustrated is a block diagram of a computer network infrastructure within which various embodiments of a data copy system for effecting multi-platform disaster recovery constructed according to the principles of the present invention can operate.

The computer network infrastructure includes a production data center 100. The production data center 100 is primarily responsible for providing data processing services under normal circumstances for, e.g., a major facility of a multinational manufacturing company. The illustrated embodiment of the production data center includes multiple platforms: one or more mainframe computers 102 and one or more minicomputers 104.

In one embodiment, the one or more mainframe computers 102 include a mainframe computer that employs Extended Binary-Coded Decimal Instruction Code (EBCDIC) to encode the instructions and data with which it operates. Those skilled in the pertinent art understand that, EBCDIC is a very old way of encoding instructions and data, having long ago been eclipsed by the American Standard Code for Information Interchange (ASCII). However, those skilled in the pertinent art also understand that EBCDIC-based mainframe computers are still in use because they still perform well. Of course, the present invention is not limited to a particular type or manufacture of mainframe computer or to a particular scheme for encoding instructions or data.

In one embodiment, the one or more minicomputers 104 include a minicomputer that is UNIX-based. Those skilled in the pertinent art are aware of the wide use of UNIX-based minicomputers.

As described above, the production data center 100 may be regarded as highly reliable, but still subject to occasional outage of the short- or long-term variety. Accordingly, it is prudent to provide a standby data center 110. The standby data center 110 is preferably located offsite and typically far from the production data center 100. The standby data center 110 may be commonly owned with the production data center 100 or may be owned and operated by a company whose business it is to provide standby data center capabilities to multiple companies. For purposes of the disclosed embodiments and without limiting the scope of the present invention, the latter will be assumed.

The standby data center 110 is illustrated as including multiple platforms: a “catcher” computer 112 and one or more servers, mainframes and minicomputers 114. Various possible functions of the catcher computer 112 will be described below. For purposes of the disclosed embodiments, the catcher computer 112 will be assumed to be commonly owned with the production data center 100 but located at or at least associated with the standby data center 110, and the one or more servers, mainframes and minicomputers 114 will be assumed to be owned by the company that owns the standby data center 110. Thus, the one or more servers, mainframes and minicomputers 114 (or portions thereof) can be owned and set-aside or leased as needed when the production data center 100 experiences an outage. The catcher computer 112 may be any type of computer, the choice of which depending upon the requirements of a particular application.

FIG. 1 further illustrates a “pitcher” computer 120. The pitcher system 120 may be physically located anywhere, but is preferably located without (outside of) the production data center 100. Various possible functions of the pitcher computer 120 will be described below. The pitcher computer 120 may be any type of computer, the choice of which depending upon the requirements of a particular application. The catcher computer 112 and the pitcher computer 120 should both be remote from the production data center 100 such that a disaster that befalls the production data center 100 would not normally be expected to befall either the catcher computer 112 or the pitcher computer 120.

A computer network 130 couples the production data center 100, the standby data center 110 and the pitcher computer 120 together. In the illustrated embodiment, the computer network 130 is an Asynchronous Transfer Mode (ATM) network. However, those skilled in the pertinent art understand that the computer network may be of any conventional or later-developed type.

The production data center 100 is coupled to the computer network 130 by a datalink 140 of relatively large bandwidth. In the illustrated embodiment, the datalink 140 is a gigabit Ethernet, or “Gig/E,” datalink, and therefore ostensibly part of a LAN, a wide-area network (WAN) or a combination of LAN and WAN. Those skilled in the art understand, however, that the datalink 140 may be of any bandwidth appropriate to a particular application.

The standby data center 110 is coupled to the computer network 130 by a datalink 150 of relatively narrow bandwidth. In the illustrated embodiment, the datalink 140 is a 20 megabit-per-second datalink, and therefore ostensibly part of a wide-area network (WAN), perhaps provisioned from a public network such as the Internet or alternatively a dedicated private datalink. Those skilled in the art understand, however, that the datalink 150 may be of any bandwidth appropriate to a particular application and may take any conventional or later-developed form.

The pitcher system 120 is coupled to the computer network 130 by a datalink 160 of relatively large bandwidth. In the illustrated embodiment, the datalink 160 is a Gig/E datalink, and therefore ostensibly part of a LAN. Those skilled in the art understand, however, that the datalink 160 may be of any bandwidth appropriate to a particular application.

It is apparent that a relatively wide datapath exists between the production data center 100 and the pitcher computer 120 relative to that between the production data center 100 or the pitcher computer 120 and the standby data center 110. Complex enterprise-wide computer networks frequently contain datalinks of various bandwidths and therefore should take those bandwidths into account in deciding how best to anticipate outages. Various embodiments of the present invention therefore recognize and take advantage of the relative differences in bandwidth among the datapaths coupling the production data center 100, standby data center 110 and pitcher computer 120. Various embodiment of the present invention also optimize the order in which computers are brought back online, so that the software they run is made available based on the criticality of the function the software performs for the company. In the case of a manufacturing company, software that controls and monitors the manufacturing operation is frequently the most critical to restoring the company's normal operation. Software that supports administrative (accounting, human resources, etc.) functions, while important, is typically not as important as software that supports manufacturing.

Having described a computer network infrastructure within which various embodiments of a data copy system for effecting multi-platform disaster recovery, various methods of backing up and restoring various platforms will now be described. Accordingly, turning now to FIGS. 2A and 2B, illustrated are respective flow diagrams of embodiments of a method of backing up a mainframe operating system to a catcher computer (FIG. 2A) and a method of restoring the mainframe operating system from the catcher computer (FIG. 2B) carried out according to the principles of the present invention.

The method of backing up the mainframe operating system to the catcher computer begins in a start step 205. In a step 210, mainframe (“MF”) operating system (“OS”) Direct Access Storage Device (DASD) are copied to file. In the illustrated embodiment, the file is encoded in EBCDIC. In a step 215, mainframe OS DASD file is compressed. Compression may be performed by any suitable conventional or later-developed technique. In a step 220, binary data is transferred by “FTPing” (transferring via the well-known File Transfer Protocol, or FTP) the compressed mainframe OS DASD file to the catcher computer in binary. In a step 225, the mainframe OS DASD file is stored on the catcher computer pending need for a recovery. The method of backing up the mainframe OS to the catcher computer ends in an end step 230.

The method of restoring the mainframe OS from the catcher computer begins in a start step 235. In a step 240, the mainframe OS DASD file is transferred via FTP from the catcher computer (described in detail above in the method of FIG. 2B) to a mainframe either at the production data center (e.g., the mainframe(s) 102) or at the standby data center (e.g., the server(s), mainframe(s) and minicomputer(s) 114). In a step 245, the mainframe OS system resident file (“sysres”) is uncompressed, and the uncompressed file is transferred to one or more mainframes. In a step 250, an initial program load is executed from the mainframe OS sysres. This begins the process of rebooting the mainframe(s). The method of restoring the mainframe OS from the catcher computer ends in an end step 255.

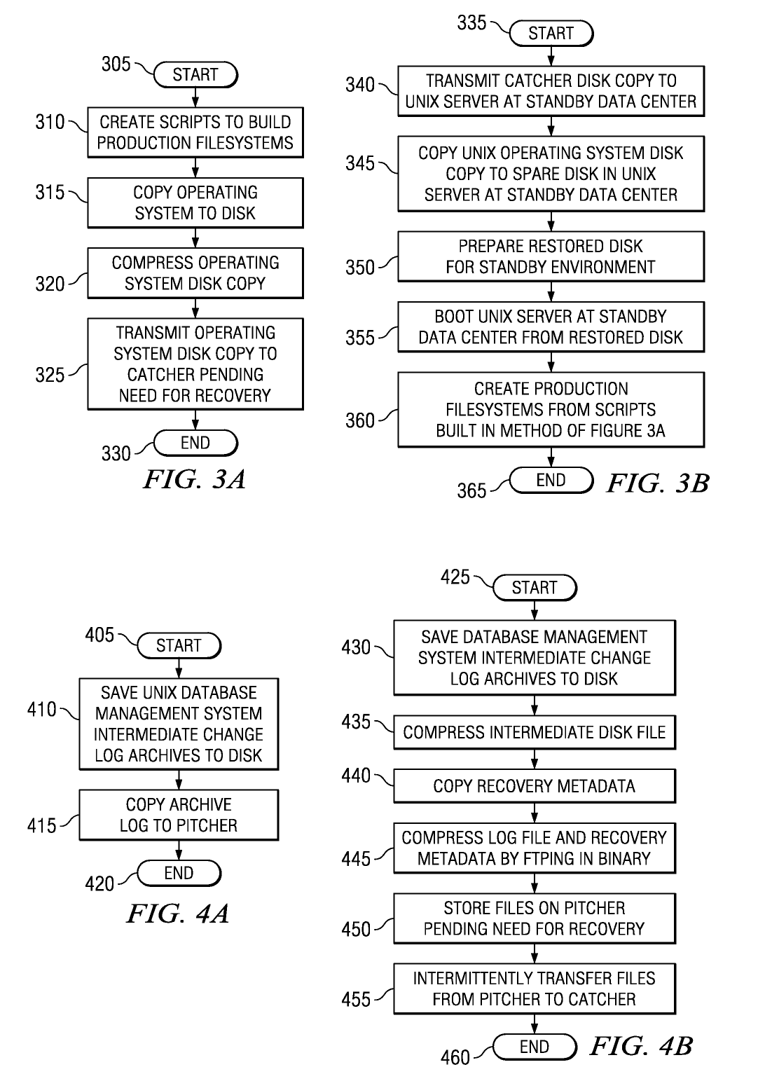

Turning now to FIGS. 3A and 3B, illustrated are respective flow diagrams of embodiments of a method of backing up a minicomputer OS (e.g., UNIX) to a catcher computer (FIG. 3A) and a method of restoring the minicomputer OS from the catcher computer (FIG. 3B) carried out according to the principles of the present invention.

The method of backing up the minicomputer OS to a catcher computer begins in a start step 305. In a step 310, scripts are created to build production filesystems. Those skilled in the pertinent art are familiar with the steps necessary to build a production filesystem from a collection of archive files and how scripts (or “batch files”) can be used to automate the building of a production filesystem. Those skilled in the pertinent art also understand that such scripts may vary widely depending upon the particular filesystem being built. A general discussion on the creation of scripts for building production filesystems is outside the scope of the present discussion. In a step 315, the OS is copied and compressed. The compression may be carried out by any conventional or later-developed technique. In a step 320, the compressed OS disk copy is transmitted to the catcher computer pending need for a recovery. The method ends in an end step 325.

The method of restoring the minicomputer OS from the catcher computer begins in a start step 330. In a step 335, the compressed OS disk copy is transferred to one or more minicomputers, either at the production data center (e.g., the minicomputer(s) 104) or at the standby data center (e.g., the server(s), mainframe(s) and minicomputer(s) 114). In FIG. 3B, it is assumed that the destination minicomputer is a UNIX server located at the standby data center. In a step 340, the compressed UNIX OS disk is uncompressed to a spare disk in the UNIX server at the standby data center. As a result, in a step 345, a restored disk is prepared that can be used if needed. When it is time to bring a UNIX server online, a UNIX server at the standby data center is booted from the restored disk in a step 350. In a step 355, production filesystems are created from the automated scripts that were built in the step 310 of FIG. 3A. The method of restoring the minicomputer OS from the catcher computer ends in an end step 360.

Turning now to FIGS. 4A and 4B, illustrated are respective flow diagrams of embodiments of a method of forward-storing minicomputer database management system logs to a pitcher computer (FIG. 4A) and a method of forward-storing mainframe database management system logs to the pitcher computer (FIG. 4B) carried out according to the principles of the present invention.

The method of forward-storing minicomputer database management system logs to the pitcher computer begins in a start step 405. In a step 410, UNIX database management system (DBMS) intermediate change log archives are saved to disk. In a step 415, an archive log is copied to the pitcher computer. The method of forward-storing minicomputer database management system logs to the pitcher computer ends in an end step 420.

The method of forward-storing mainframe database management system logs to the pitcher computer begins in a start step 425. In a step 430, DBMS intermediate change log archives are saved to disk in a file. In a step 435, the disk file containing the intermediate disk file is compressed. The compression may be carried out by any conventional or later-developed technique. In a step 440, recovery metadata is copied to a file. In a step 445, the log file and recovery metadata file are copied to the pitcher computer by FTPing the files to the pitcher computer in binary. In a step 450, the files are stored on the pitcher computer pending a need for recovery. In a step 455, the files may be intermittently transferred (or “trickled”) from the pitcher computer to the catcher computer. The method of forward-storing the mainframe database management system logs to the pitcher computer ends in an end step 460.

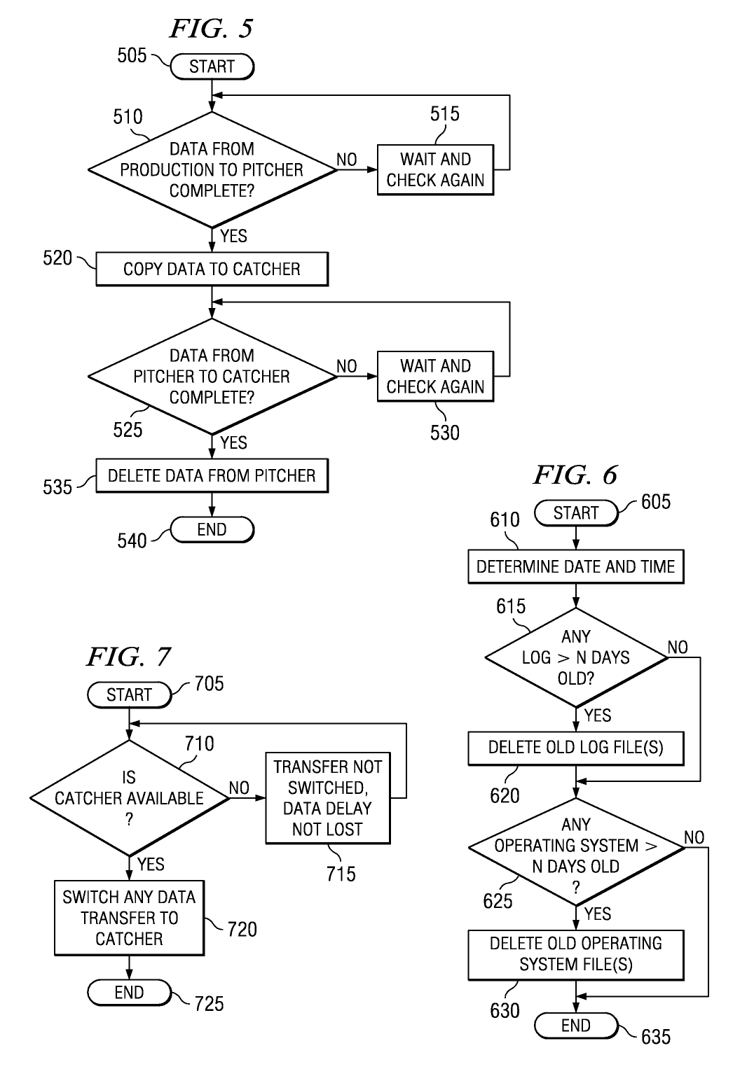

Turning now to FIG. 5, illustrated is a flow diagram of an embodiment of a method of transferring data from a pitcher computer to a catcher computer carried out according to the principles of the present invention.

The method begins in a start step 505. In a decisional step 510, it is determined whether data transfer from the production computer (which may be any computer at the production data center) to the pitcher computer is complete. If the data transfer is not complete, some time is allowed to pass (in a step 515), and data transfer completion is checked again in the decisional step 510. If the data transfer is complete, in a step 520, data is copied to the catcher computer. In a decisional step 525, it is determined whether data transfer from the pitcher computer to the catcher computer is complete. If the data transfer is not complete, some time is allowed to pass (in a step 530), and data transfer completion is checked again in the decisional step 525. If the data transfer is complete, data is deleted from the pitcher computer in a step 535. The method ends in an end step 540.

Turning now to FIG. 6, illustrated is a flow diagram of an embodiment of a method of cleaning data on a pitcher computer or a catcher computer carried out according to the principles of the present invention.

The method begins in a start step 605. In a step 610, the current date and time are determined. In a decisional step 615, it is determined whether any log file is greater than a predetermined number (N) days old. If so, the log file or files are deleted in a step 620. If not, in a decisional step 625, it is determined whether any OS file is greater than N days old. If so, the OS file or files are deleted in a step 630. The method ends in an end step 635.

Turning now to FIG. 7, illustrated is a flow diagram of an embodiment of a method of preventing missed data due to outage of a pitcher computer carried out according to the principles of the present invention.

The method begins in a start step 705. In a decisional step 710, it is determined whether the catcher computer is available. If the catcher computer is not available, then the transfer is not switched in a step 715, and data is not lost, but only delayed, as a result. If the catcher computer is available, pending data transfers are switched to the catcher computer in a step 720. The method ends in an end step 725.

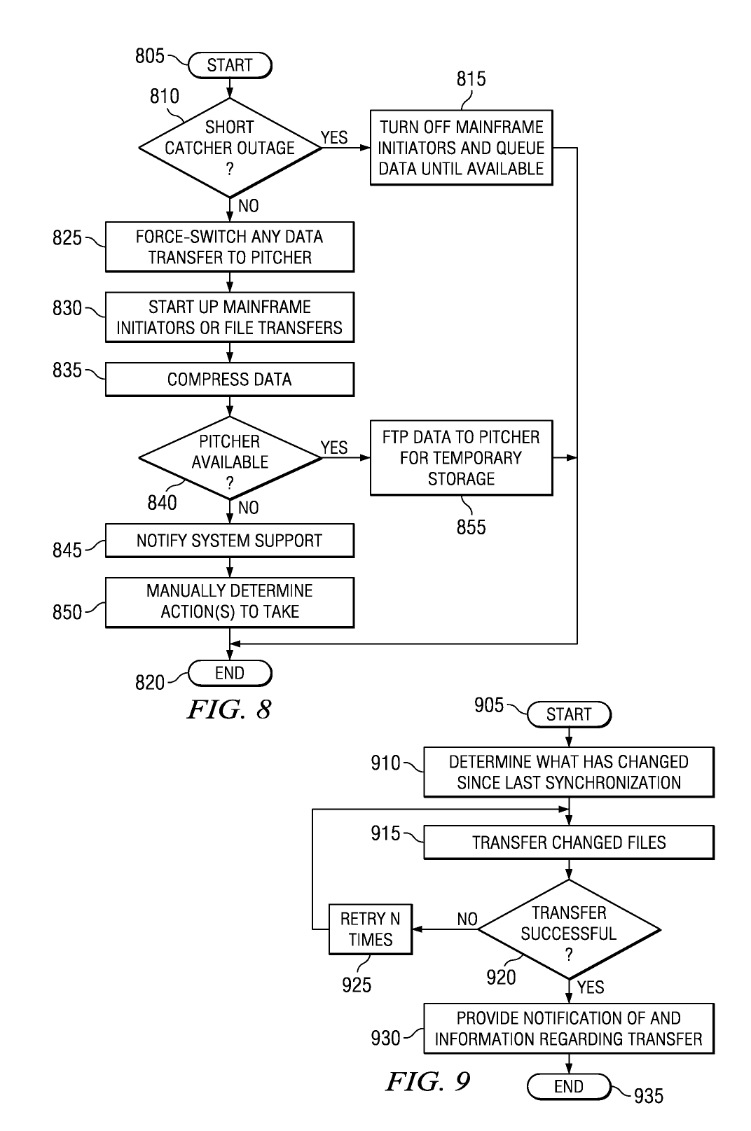

Turning now to FIG. 8, illustrated is a flow diagram of an embodiment of a method of preventing missed data due to outage of a catcher computer carried out according to the principles of the present invention.

The method begins in a start step 805. In a decisional step 810, it is determined whether the outage of the catcher computer is a short-term outage (as opposed to a long-term outage). If the outage of the catcher computer is a short-term outage, mainframe initiators are turned off and data is queued until the catcher computer becomes available in a step 815. The method then ends in an end step 820. If, on the other hand, the outage of the catcher computer is a long-term outage, it is then determined whether the pitcher computer is available in a decisional step 825. If the pitcher computer is available, data transfers are force-switched to the pitcher computer in a step 830. In a step 835, mainframe initiators or file transfers are started up. In a step 840, the data is compressed. In a step 845, the data is transferred by FTP to the pitcher computer for temporary storage. The method then ends in the end step 820. If, on the other hand, the pitcher computer is not available, system support is notified in a step 850. In a step 855, system support manually determines the action or actions to take, and the method ends in the end step 820.

Turning now to FIG. 9, illustrated is a flow diagram of an embodiment of a method of transferring data to a Microsoft.®. Windows.®.-based catcher computer carried out according to the principles of the present invention.

The method begins in a start step 905. In a step 910, it is determined what has changed since last synchronization. In a step 915, the changed files are transferred. This is often referred to as an incremental backup. In a decisional step 920, it is determined whether the transfer was successful. If not, in a step 925, the transfer is retried a predetermined number (N) of times. If the transfer was successful, notification of and information regarding the transfer is provided in a step 930. The method ends in an end step 935.

Those skilled in the art to which the invention relates will appreciate that other and further additions, deletions, substitutions and modifications may be made to the described embodiments without departing from the scope of the invention.

What is claimed is:

1. A method of providing disaster recovery with respect to a production mainframe having an operating system encoded in Extended Binary Coded Decimal Instruction Code (EBCDIC), comprising:
copying said operating system from a direct access storage device (DASD) of said production mainframe to a file;
compressing said file;
transferring said file to a remote computer by binary File Transfer Protocol; and storing said file proximate said remote computer.

2. The method as recited in claim 1 further comprising:
uncompressing said file;
providing said operating system to a DASD of a target mainframe; and
executing a system resident file of said operating system.

3. The method as recited in claim 2 wherein said target mainframe is said production mainframe.

4. The method as recited in claim 2 wherein said target mainframe is associated with a standby data center.

5. A method of providing disaster recovery with respect to a production minicomputer having an operating system, comprising:
creating at least one script to build a production filesystem;
copying said operating system to a disk;
compressing a file representing a contents of said disk; and
transmitting said file to a remote computer.

6. The method as recited in claim 5 further comprising:
transferring said file to a spare disk of a target minicomputer; and
employing said script to build said production filesystem.

7. The method as recited in claim 5 wherein said minicomputer is a UNIX server.

8. The method as recited in claim 6 wherein said target minicomputer is said production minicomputer.

9. The method as recited in claim 6 wherein said target minicomputer is associated with a standby data center.

10. A method of forward-storing database management system (DBMS) logs, comprising:
saving archives of said DBMS logs to disk; and
transferring a contents of said disk to a remote computer associated with a standby data center.

11. The method as recited in claim 10 herein said DBMS logs are UNIX DBMS logs and said remote computer is located without said production center.

12. The method as recited in claim 10 wherein said DBMS logs are mainframe DBMS logs and said remote computer is associated with a standby data center.

13. The method as recited in claim 10 wherein said DBMS logs are Windows-based DBMS logs and said remote computer is associated with a standby data center.

14. The method as recited in claim 10 wherein said DBMS logs are mainframe DBMS logs, said saving comprises compressing a contents of said disk after said saving and copying recovery metadata associated with said mainframe DBMS logs and said transferring comprises transferring said contents and said recovery metadata to said remote computer by binary File Transfer Protocol, said transferring compressing said contents and said recovery metadata.
